(19) United States
(12) Patent Application Publication
(10) Pub. No.: US 2023/0417411 A1
(43) Pub. Date: Dec. 28, 2023

(54) Temperature Control System of a Gas Oven

(71) Applicant: Ningbo Laite Gas Stoves Co., Ltd., Ningbo (CN)

(72) Inventor: Xuebo Li, Ningbo (CN)

(21) Appl. No.: 17/820,669

(22) Filed: Aug. 18, 2022

(30) Foreign Application Priority Data
Jun. 28, 2022 (CN) 202210749873.7

(51) Int. Cl. F23N 1/00; F24C 3/12; F23N 5/02

(52) U.S. Cl. CPC F23N 1/002; F24C 3/126; F23N 5/022; F23N 2225/08; F23N 2229/00; F23N 2235/12

(57) ABSTRACT

A temperature control system of a gas oven, the gas oven has an oven chamber (1), the temperature control system has burners (2) disposed inside the oven chamber (1), gas nozzles (3) supplying gas to each burner (2); a temperature-controlled gas valve (5) with a temperature sensing rod (4); the temperature-controlled gas valve (5) has a valve rod (51) capable of rotating to different angles to set different working temperatures of the gas oven; the temperature-controlled gas valve (5) has a gas outlet (52) delivering gas to each gas nozzle (3) through a gas distribution mechanism; the temperature sensing rod (4) extends into the oven chamber (1) for sensing current temperature; the temperature-controlled gas valve (5) has a regulating mechanism (53).

### TECHNICAL FIELD OF THE INVENTION

The present invention relates to a temperature control system suitable for a gas oven.

### BACKGROUND OF THE INVENTION

Temperature-controlled gas valves with temperature sensing rods are generally used in gas ovens. Since a relatively closed space is formed in the casing of the gas oven during its operation, the temperature sensing rod can accurately sense the temperature, so that the action of the regulating structure in the temperature-controlled gas can be controlled and the gas outlet amount can be stably regulated according to the setting. The existing gas oven (gas BBQ for short) generally comprises a furnace body and a burner disposed in the furnace body. The barbecuing process is open, so it is not suitable for automatic temperature control by the temperature-controlled gas valve with the temperature sensing rod. For this reason, the gas flow is mostly controlled manually to control the fire power. A control valve is disposed on the front panel of the furnace body for control, and an electronic pulse igniter is provided for ignition.

For some gas ovens, a plurality of burners arranged side by side are disposed in the furnace body, and the control value consists of a main control valve and a plurality of sub-control valves. The main control valve is responsible for igniting and turning on or off the total gas source, and each of the sub-control valves corresponds to one burner to control the gas volume of a single burner so as to control the fire of the single burner. For such gas ovens, the fire power can only be controlled by manually regulating the gas flow of the valve, so as to achieve the desired barbecue temperature.

For example, both Chinese Utility Model Patent CN205338700U (patent No.: ZL201620037218.9) entitled “NOVEL GAS OVEN” and Chinese Utility Model Patent CN201135373Y (patent No.: CN200720153810.6) entitled “VERTICAL ROTARY GAS OVEN” disclosed such ovens.

With the progress of technology, the gas oven will be equipped with a bonnet, and the bonnet is well sealed with the furnace body. When the bonnet is opened, the gas oven is used as a conventional gas oven for fast barbecuing. When the bonnet is closed by the operator, the temperature in the oven chamber will be increased quickly. However, the bonnet needs to be opened immediately, otherwise it is easy to overheat food. So it requires the barbecue person must have some BBQ experience to make the food fast and delicious.

In sum, the existing gas ovens are unsatisfactory for users in terms of use function, are inconvenient to use, not satisfied the requirements of humanized operation, and not easy to ensure the food barbecuing effect.

### SUMMARY OF THE INVENTION

It is an object of the present invention to provide a temperature control system of a gas oven which is reasonable and simple in structural design and can realize the automatic temperature control function when the bonnet is closed.

For achieving the above object, the temperature control system of a gas oven, the gas oven has an oven chamber, the temperature control system comprises a plurality of burners disposed inside the oven chamber; a plurality of gas nozzles supplying gas to each burner; a temperature-controlled gas valve with a temperature sensing rod; wherein, the temperature-controlled gas valve has a valve rod capable of rotating to different angles to set different working temperatures of the gas oven; the temperature-controlled gas valve has a gas outlet delivering gas to each gas nozzle through a gas distribution mechanism; the temperature sensing rod extends into the oven chamber for sensing current temperature in the oven chamber; the temperature-controlled gas valve has a regulating mechanism; when the current temperature in the oven chamber is lower than a set value, the gas outlet of the temperature-controlled gas valve delivers gas at a high flow, and when the current temperature in the oven chamber is higher than the set value, the regulating mechanism reduces delivery of the gas to the gas outlet of the temperature-controlled gas valve.

Preferably, the gas distribution mechanism comprises a multi-pass connector with a plurality of outlet ends connected to the gas outlet of the temperature-controlled gas valve, and a gas pipe is connected between each outlet end of the multi-pass connector and the corresponding gas nozzle. This gas distribution mechanism has few design components and is reasonable in structural design.

Preferably, the gas distribution mechanism comprises a gas distribution pipe disposed inside the oven chamber, and each gas nozzle is mounted on the gas distribution pipe and communicated with the gas distribution pipe; the gas distribution pipe has a gas inlet end; and the gas outlet end of the temperature-controlled gas valve is connected to the gas inlet end through a connecting pipe. The gas distribution mechanism is convenient to mount. The gas distribution pipe is mounted in the oven chamber in advance, and each gas nozzle is mounted in place in advance. Thus, it is very convenient for the gas oven manufacturer to connect the temperature-controlled gas valve, and it is only necessary to connect the gas outlet end of the temperature-controlled gas valve to the gas inlet end on the gas distribution pipe through a connecting pipe, so that it is advantageous for the manufacturer's assembly.

Preferably, the temperature control system further comprises an ignition device placed adjacent to the burners and a micro-switch placed outside the temperature-controlled gas valve; the micro-switch is connected to the ignition device to control the ignition device; a trigger tray capable of rotating with the valve rod is connected to the valve rod; in an initial state, the micro-switch is not triggered by the trigger tray, only when the valve rod is pressed down, the trigger tray is capable of triggering the micro-switch, so as to make the ignition device to ignite. The ignition device can be controlled by the operation knob of the temperature-controlled gas valve, without needing any external igniter (ignition gun).

Alternatively, preferably, the ignition device is an ignition needle with a pulser, or an ignition plug. The ignition needle or the ignition plug has the respective advantages and disadvantages in structure, but the ignition needle is cheaper. The ignition plug is expensive, and has the advantage that the gas source is connected after ignition for a certain period of time, to ensure effective ignition.

Preferably, the temperature control system further comprises a potentiometer and a circuit board with a display screen which are in communication with each other; the potentiometer is disposed in upper portion of the temperature-controlled gas valve, a rotor in the potentiometer is partially sheathed on the valve rod of the temperature-controlled gas valve and is capable of being driven by the valve rod to rotate to detect the angle of rotation of the valve rod; and the display screen on the circuit board is capable of displaying the set temperature according to the angle of rotation of the valve rod. In this design, the temperature control system is more intelligent, and the set temperature can be visually observed on the display, so that the product grade is greatly improved. The fire of the conventional gas oven can only be seen through the scale around the knob of the control valve.

Preferably, the temperature control system further comprises a temperature detector in communication with the circuit board; the temperature detector extends into the oven chamber to detect the current temperature in the oven chamber, and transmits the current temperature to the circuit board; and the display screen on the circuit board is capable of displaying the current temperature in the oven chamber. The temperature detector can detect the actual temperature in the oven chamber in real time, so that the fire for barbecuing food is better controlled, and the barbecued food is more delicious and difficult to be burned or underdone.

Preferably, the temperature control system further comprises a flame detection needle in communication with the circuit board; the flame detection needle extends into the oven chamber to detect whether the burners are burning; and a flame indicator light for displaying whether the burners are burning is disposed on the circuit board. The operator can close the bonnet of the gas oven.

Compared with the prior art, the present invention has the following advantages. In the temperature control system, the gas is distributed to each burner through the temperature-controlled gas valve with a temperature sensing rod, and the temperature sensing rod extends into the oven chamber to sense the temperature in the oven chamber, so that the gas oven with a bonnet has the barbecuing function of the conventional oven and can also has the function of the gas oven. When the bonnet is opened, since the temperature sensing rod is also exposed to air, the internal temperature is mixed with the external temperature, and the temperature sensed by the temperature sensing rod is lower than the set temperature, so that the regulating structure is in a maximum flow state, and the temperature (fire) can be regulated by the rotation of the valve rod. However, when the bonnet is closed, a relatively closed barbecuing space is formed, and the temperature of air in the oven chamber is increased. At this time, the temperature sensing rod plays a role. In the beginning stage, the temperature in the oven chamber does not reach the set temperature, the air outlet end of the temperature-controlled gas valve outputs gas at a high flow, and the burners are in a high fire state. When the temperature in the oven chamber is higher than the set temperature, the regulating structure in the temperature-controlled gas valve acts to reduce the gas outlet amount at the gas outlet end of the temperature-controlled gas valve, and the burners are in a low fire state. When the temperature in the oven chamber is lower than the set temperature, the regulating structure in the temperature-controlled gas valve acts to increase the gas outlet amount at the gas outlet end of the temperature-controlled gas valve, and the burners are in the high fire state again, so that the barbecue functions as a gas oven.

### BRIEF DESCRIPTION OF THE DRAWINGS

FIG. 1 is a schematic diagram of a temperature control system of a gas oven according to Embodiment 1 of the present invention;

FIG. 2 is a first perspective view of a temperature-controlled gas valve of the temperature control system according to Embodiment 1 of the present invention;

FIG. 3 is a second perspective view of the temperature-controlled gas valve of the temperature control system according to Embodiment 1 of the present invention;

FIG. 4 is a sectional view of the temperature-controlled gas valve of the temperature control system according to Embodiment 1 of the present invention;

FIG. 5 is a schematic diagram of the temperature control system of a gas oven according to Embodiment 2 of the present invention.

### DETAILED DESCRIPTION OF THE INVENTION

The present invention will be further described in detail below by embodiments with reference to the accompanying drawings.

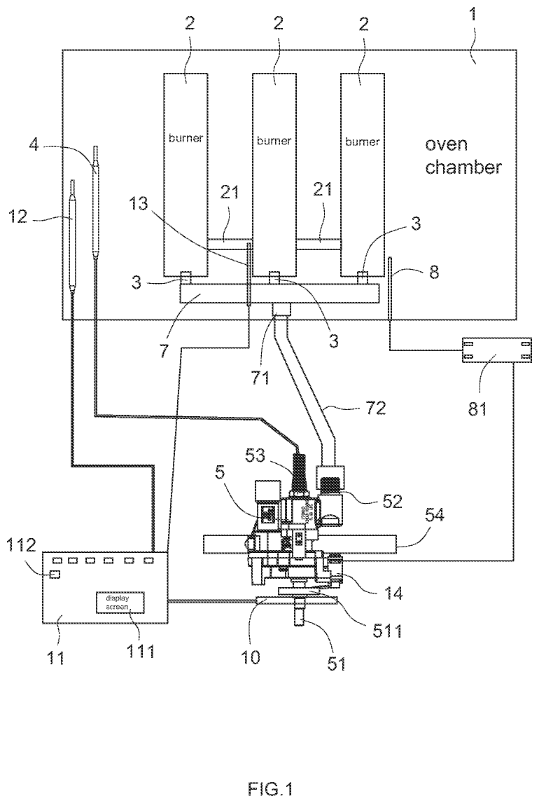

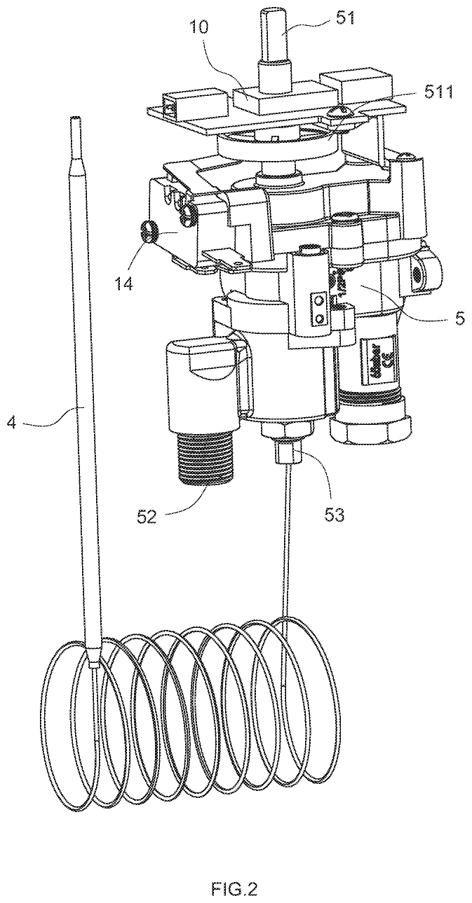

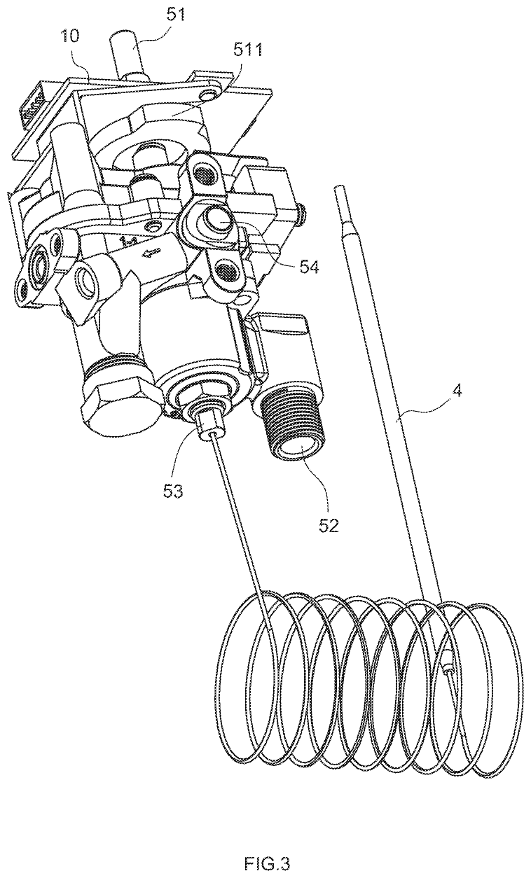

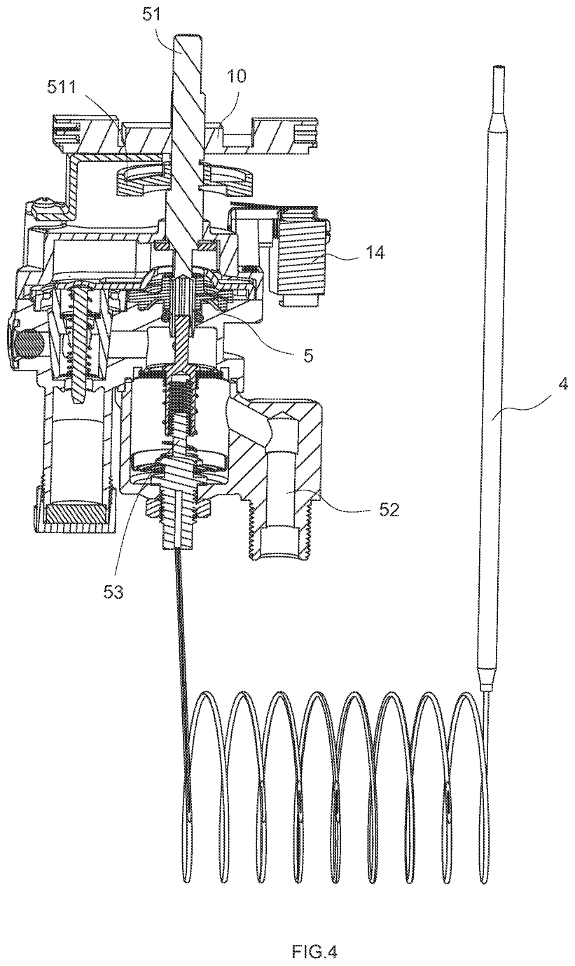

FIGS. 1-4 show a preferred embodiment of the temperature control system of a gas oven of the present invention.

The gas oven has an oven chamber 1, the temperature control system of the gas oven comprises a plurality of burners 2 disposed inside the oven chamber 1, a plurality of gas nozzles 3 supplying gas to each burner 2, and a temperature-controlled gas valve 5 with a temperature sensing rod 4. In this embodiment, there are three burners 2, among which a fire transmission rank 21 needs to be arranged for better fire transmission.

The temperature-controlled gas valve 5 has a gas inlet end 54 which is connected to a gas tank. The temperature-controlled gas valve 5 has a valve rod 51 capable of rotating to different angles to set different working temperatures of the gas oven; the temperature-controlled gas valve 5 has a gas outlet 52 delivering gas to each gas nozzle 3 through a gas distribution mechanism; the temperature sensing rod 4 extends into the oven chamber 1 for sensing current temperature in the oven chamber 1; the temperature-controlled gas valve 5 has a regulating mechanism 53; when the current temperature in the oven chamber 1 is lower than a set value, the gas outlet 52 of the temperature-controlled gas valve 5 delivers gas at a high flow, and when the current temperature in the oven chamber 1 is higher than the set value, the regulating mechanism 53 reduces delivery of the gas to the gas outlet 52 of the temperature-controlled gas valve 5. The temperature sensing rod 4 can transfer a thermal signal to the regulating mechanism 53 in the temperature-controlled gas value 5 to act the regulating mechanism 53. This is the prior art.

The temperature-controlled gas valve 5 with the temperature sensing rod 4 may be a temperature-controlled gas valve with an ever-burning fire function, which may refer to the applicant's Application Patent CN210531679U entitled “MACHANISM-IMPROVED TEMPERATURE-CONTROLLED VALVE WITH EVER-BURNING FIRE FUNCTION”, or the applicant's Application Patent CN212377363U entitled “MACHANISM-OPTIMIZED TEMPERATURE-CONTROLLED VALVE WITH EVER-BURNING FIRE FUNCTION”, or other existing temperature-controlled gas valve mechanisms with temperature sensing rods.

Preferably, the gas distribution mechanism in this embodiment comprises a gas distribution pipe 7 disposed inside the oven chamber 1, and each gas nozzle 3 is mounted on the gas distribution pipe 7 and communicated with the gas distribution pipe 7; the gas distribution pipe 7 has a gas inlet end 71; and the gas outlet end 52 of the temperature-controlled gas valve 5 is connected to the gas inlet end 71 through a connecting pipe 72.

The temperature control system further comprises an ignition device 8 placed adjacent to the burners 2, and the ignition device 8 is an ignition needle with a pulser 81, or an ignition plug. A micro-switch 14 placed outside the temperature-controlled gas valve 5; the micro-switch 14 is connected to the ignition device 8 to control the ignition device 8; a trigger tray 511 capable of rotating with the valve rod 51 is connected to the valve rod 51; in an initial state, the micro-switch 14 is not triggered by the trigger tray 511, only when the valve rod 5 is pressed down, the trigger tray 511 is capable of triggering the micro-switch 14, so as to make the ignition device 8 to ignite.

The temperature control system further comprises a potentiometer 10 and a circuit board 11 with a display screen 111 which are in communication with each other; the potentiometer 10 is disposed in upper portion of the temperature-controlled gas valve 5, a rotor in the potentiometer 10 is partially sheathed on the valve rod 51 of the temperature-controlled gas valve 5 and is capable of being driven by the valve rod 51 to rotate to detect the angle of rotation of the valve rod 51; and the display screen 111 on the circuit board 11 is capable of displaying the set temperature according to the angle of rotation of the valve rod 51. The potentiometer 10 is a purchased part, and is commercially-available. The specific internal structure of the potentiometer is not shown in the drawings.

The temperature control system further comprises a temperature detector 12 in communication with the circuit board 11; the temperature detector 12 extends into the oven chamber 1 to detect the current temperature in the oven chamber 1, and transmits the current temperature to the circuit board 11; and the display screen 111 on the circuit board 11 is capable of displaying the current temperature in the oven chamber 1.

The temperature control system further comprises a flame detection needle 13 in communication with the circuit board 11; the flame detection needle 13 extends into the oven chamber 1 to detect whether the burners 2 are burning; and a flame indicator light 112 for displaying whether the burners 2 are burning is disposed on the circuit board 11.

The operation principle and process of the temperature control system of a gas oven will be described below.

The valve rod 51 of the temperature-controlled gas valve 5 is pressed down and rotated anticlockwise to the set angle (such as 50 degrees), and the valve rod 51 drives the trigger tray 511 to trigger the micro-switch 14 to give out a signal indicating that ignition can be performed. Meanwhile, the valve rod 51 drives the rotor in the potentiometer 10 to rotate to give out a signal to the circuit board 11. The angle of rotation is equal to the set temperature, and the set temperature will be displayed on the display screen 111 of the circuit board 11. After the gas is fed and the ignition is performed, the three burners 2 are all in a high fire state.

When the bonnet is opened, the internal temperature is mixed with the external temperature, and the temperature sensed by the temperature sensing rod 4 is lower than the set temperature, so that the regulating mechanism 53 is in a maximum flow state, and the temperature (fire) can be regulated by the rotation of the valve rod 51. When the bonnet is closed, a relatively closed barbecuing space is formed, and the temperature of air in the oven chamber 1 is increased. At this time, the temperature sensing rod 4 plays a role. In the beginning stage, the temperature in the oven chamber 1 does not reach the set temperature, the air outlet end of the temperature-controlled gas valve 5 outputs gas at a high flow, and the burners 2 are in a high fire state. When the temperature in the oven chamber 1 is higher than the set temperature, the regulating mechanism 53 in the temperature-controlled gas valve 5 acts to reduce the gas outlet amount at the gas outlet end of the temperature-controlled gas valve 5, and the burners 2 are in a low fire state. When the temperature in the oven chamber 1 is lower than the set temperature, the regulating mechanism 53 in the temperature-controlled gas valve 5 acts to increase the gas outlet amount at the gas outlet end of the temperature-controlled gas valve 5, and the burners 2 are in the high fire state again, so that the barbecue functions as a gas oven. Thus, the gas oven with a bonnet has the barbecuing function of the conventional oven and can also has the function of the gas oven

The action principles of the temperature sensing rod and the regulating mechanism are the prior art and will not be repeated here.

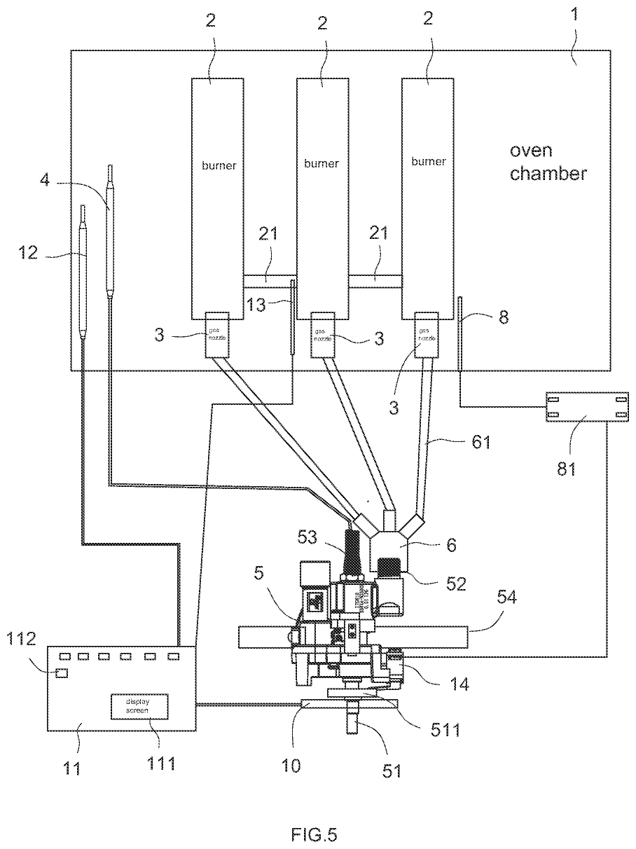

FIG. 5 shows a second preferred embodiment of the present invention.

This embodiment differs from the above embodiment in that: the gas distribution mechanism comprises a multi-pass connector 6 with a plurality of outlet ends connected to the gas outlet 52 of the temperature-controlled gas valve 5, and a gas pipe 61 is connected between each outlet end of the multi-pass connector 6 and the corresponding gas nozzle 3.

It is to be noted that, in the description of this embodiment, orientations or location relationships indicated by terms such as “front, behind”, “left, right”, “upper, lower” are the orientations and location relationships illustrated on the basis of the accompany drawings. Such terms are used just for ease of describing the present invention and simplifying the description, and it is not indicated or implied that the stated device or element must have a specific orientation or must be constructed and operated in the specific orientation, and shall not be interpreted as any limitation to the present invention. Terms “mounted”, “connected to” and “connected with” should be understood in a broad sense. For example, the connection may be fixed connection or detachable connection or integral connection. The connection may be direct connection, or indirect connection with a mediator therebetween. The connection may be the communication between two elements. For a person of ordinary skill in the art, the specific meaning of the aforementioned terms in the present invention can be understood in specific circumstances.

1. A temperature control system of a gas oven, the gas oven having an oven chamber, the temperature control system comprising:
a plurality of burners disposed inside the oven chamber;
a plurality of gas nozzles supplying gas to each burner;
a temperature-controlled gas valve with a temperature sensing rod;
wherein,
the temperature-controlled gas valve has a valve rod capable of rotating to different angles to set different working temperatures of the gas oven;
the temperature-controlled gas valve has a gas outlet delivering gas to each gas nozzle through a gas distribution mechanism;
the temperature sensing rod extends into the oven chamber for sensing current temperature in the oven chamber;
the temperature-controlled gas valve has a regulating mechanism;
when the current temperature in the oven chamber is lower than a set value, the gas outlet of the temperature-controlled gas valve delivers gas at a high flow, and when the current temperature in the oven chamber is higher than the set value, the regulating mechanism reduces delivery of the gas to the gas outlet of the temperature-controlled gas valve.

2. The temperature control system of claim 1, wherein the gas distribution mechanism comprises a multi-pass connector with a plurality of outlet ends connected to the gas outlet of the temperature-controlled gas valve, and a gas pipe is connected between each outlet end of the multi-pass connector and the corresponding gas nozzle.

3. The temperature control system of claim 1, wherein the gas distribution mechanism comprises a gas distribution pipe disposed inside the oven chamber, and each gas nozzle is mounted on the gas distribution pipe and communicated with the gas distribution pipe;
the gas distribution pipe has a gas inlet end; and
the gas outlet end of the temperature-controlled gas valve is connected to the gas inlet end through a connecting pipe.

4. The temperature control system of claim 1, wherein further comprises an ignition device placed adjacent to the burners and a micro-switch placed outside the temperature-controlled gas valve;
the micro-switch is connected to the ignition device to control the ignition device;
a trigger tray capable of rotating with the valve rod is connected to the valve rod;
in an initial state, the micro-switch is not triggered by the trigger tray, only when the valve rod is pressed down, the trigger tray is capable of triggering the micro-switch, so as to make the ignition device to ignite.

5. The temperature control system of claim 4, wherein the ignition device is an ignition needle with a pulser, or an ignition plug.

6. The temperature control system of claim 1, wherein further comprises a potentiometer and a circuit board with a display screen which are in communication with each other;
the potentiometer is disposed in upper portion of the temperature-controlled gas valve, a rotor in the potentiometer is partially sheathed on the valve rod of the temperature-controlled gas valve and is capable of being driven by the valve rod to rotate to detect the angle of rotation of the valve rod; and
the display screen on the circuit board is capable of displaying the set temperature according to the angle of rotation of the valve rod.

7. The temperature control system of claim 6, wherein further comprises a temperature detector in communication with the circuit board;
the temperature detector extends into the oven chamber to detect the current temperature in the oven chamber, and transmits the current temperature to the circuit board; and
the display screen on the circuit board is capable of displaying the current temperature in the oven chamber.

8. The temperature control system of claim 6, wherein further comprises a flame detection needle in communication with the circuit board;
the flame detection needle extends into the oven chamber to detect whether the burners are burning; and
a flame indicator light for displaying whether the burners are burning is disposed on the circuit board.
